(19) United States
(12) Patent Application Publication
(10) Pub. No.: US 2013/0204668 A1
(43) Pub. Date: Aug. 8, 2013

(54) Energy Price Protection Method for Business and Residential Structures

(71) Applicants: Lance W. Schneier, Dublin, OH (US); Thomas S. Reichelderfer, Upper Arlington, OH (US); Sudheer Pimputkar, Worthington, OH (US)

(72) Inventors: Lance W. Schneier, Dublin, OH (US); Thomas S. Reichelderfer, Upper Arlington, OH (US); Sudheer Pimputkar, Worthington, OH (US)

(21) Appl. No.: 13/364,375

(22) Filed: Feb. 2, 2012

(51) Int. Cl. G06Q 30/02

(52) U.S. Cl. 705/7.34

(57) ABSTRACT

A method for protecting consumers against increases in the price of energy, especially for their residential and/or business structures. The protection may be provided for an agreed-in-advance quantity of energy and/or for an agreed-in-advance duration.

### CROSS-REFERENCE TO RELATED APPLICATIONS

This application claims priority to co-pending U.S. application Ser. No. 12/322,577, filed on Feb. 4, 2009, itself claiming priority to U.S. Provisional Application Ser. No. 61/063,532, filed on Feb. 4, 2008, both disclosures of which are incorporated by reference herein.

### FIELD OF THE INVENTION

The present invention relates to consumer price protection for different types of energy purchased at retail. More particularly, this invention relates to a system and method for subscribing consumers to protect them from price increases in the energy form or forms they purchase on a regular or periodic basis especially for business and/or residential structure purchasing. The invention provides consumer price protection regardless of whether actual energy products are purchased and/or actual energy product (natural gas, power, etc.) is ever physically transferred from the energy provider to the subscribing consumer.

### BACKGROUND OF THE INVENTION

In recent years, fuel prices have tended to fluctuate unpredictably, usually due to factors outside the control of consumers. International oil prices can vary daily, and often widely, with current Middle East political conditions and the possibility of further conflict expansion. The refining of oil and oil products may be shut down, or at least curtailed, when hurricanes and other violent weather threaten offshore facilities.

Consumers of various fuel products may desire a system that protects them against energy price volatility. Such a system would provide an energy price protection plan that addresses fluctuations over time. Energy consumers would be able to safeguard themselves by subscribing to an energy protection plan that cushions against unpredictable price swings. This plan would be especially desirable if it rewarded subscribers with credits or refunds if the price increase for a prescribed time period was greater than expected. Preferably, any such consumer price protection program should extend to multiple, or numerous, energy types and not just the gasoline products consumed by most automobiles today.

Several recent references propose incentivizing automobile sales by including therewith a vehicular fuel price protection method. See, for example, Miller et al. U.S. Published Patent Application Serial No. 20070038553 and Hadjukiewicz et al. U.S. Pat. No. 6,980,960. This invention differs from the aforementioned prior art in the following critical ways:
The prior art systems are not stand-alone programs; they are concomitant upon the purchase or acquisition of product . . . in many cases, the very energy product being bought and consumed directly by the customer. In other instances, it is to encourage purchases of closely related product via fuel price incentivization.
The intent of the Miller et al. published application is to boost sales of a product (e.g., automobiles). It is not intended to protect against energy price increases. As such, the Miller et al. consumer has no discretion in extending the period of price stability, nor is he/she able to access price stability without purchase of the underlying, related (or “tied”) product.
Both prior art systems focused primarily on, and restricted themselves to, one fuel—gasoline for cars and trucks.
The present invention clearly establishes objective, third-party price references whereby the consumer can assure himself of the transparency and fairness of the pricing calculations.

This invention also differs substantially from any known utility budget payment plan. The latter serve as mere “cash flow mechanisms” with THIS MONTH's annualized average payment plan being based solely on LAST YEAR's total annual consumption, through all four weather seasons, divided by 12. In those “plans”, the consumer pays based on how they bought AND USED for the previous preset period (most often annually). It is a zero sum game with a necessary “catch up” crediting or debiting at the end of the term. This invention, by sharp contrast, does not require any physical delivery of energy to the consumer's house or business. Nor is there any true-up wherein the consumer could owe more. It is more of a financial hedging/protection against an outrageous, unplanned budget expense due to increased fuel costs, mostly for structural fuels supplied. There is NO physical equivalent to today's current utility budget planning. In fact, the method and system of this invention does not even depend directly from whom the enrolling/subscribing customer eventually purchases his/her structural energy needs . . . or if they need to purchase any (let alone any excess quantities) for that matter for any given period of energy price protection coverage.

### SUMMARY OF THE INVENTION

In accordance with one aspect of the present invention, protection is provided against increases in the price of energy. As an example, the protection may be provided for a specified quantity of energy and for a specified duration.

Another aspect relates to a method of providing quantitative value to a consumer in a consumer transaction, including providing energy price protection for a quantity of energy over a time period, said method (and related system) providing payment to the consumer based on the difference between a first value of an established energy price and a second value related to the actual energy price if the second value exceeds the first value . . . once again, regardless of whether such quantities were actually purchased and from whom. This invention requires NO SET list of preferred energy vendor/suppliers per se.

Another aspect relates to a method of providing energy price protection, including acquiring financial instruments to acquire physical or derivative energy products at future times, based, at least in part, on:
the cost to acquire such financial instruments,
the anticipated value of such financial instruments during a prescribed time frame,
determining a commercially valuable price at which to sell energy price protection for a quantity of energy, and
providing payment to a consumer based on the difference between an established energy price and the actual price of the energy quantity, if the second value exceeds the first value.

Another aspect relates to a method of providing price protection for energy, that essentially guarantees that the effective cost (cost to the subscription/purchaser) per unit of energy, up to a limiting quantity, over a given time period will not exceed a predetermined price.

These and other objects, features, advantages and functions of the invention will become more apparent as the following description proceeds.

It will be appreciated that although the invention is described with respect to one or more embodiments, the scope of the invention is limited only by the claims and equivalents thereof. It also will be appreciated that although the invention may be described with respect to several embodiments, features of a given embodiment also may be used with one or more other embodiments.

To the accomplishment of the foregoing and related ends, the invention comprises a system and method of providing quantitative value to a consumer in a consumer transaction. The system and method comprises providing energy price protection for a quantity of energy purchased over a time period. The system and method includes providing payment to the consumer based on the difference between a first value of an established energy price and a second value related to the actual price of the energy quantity if the second value exceeds the first value.

### BRIEF DESCRIPTION OF THE DRAWINGS

Further features, objects and advantages will become clearer when reviewing the detailed description of preferred embodiments made with reference to the accompanying drawings in which:

FIG. 1 is a block diagram schematically illustrating an energy price protection (EPP) system and method according to one embodiment of this invention;

FIG. 2 is a block diagram schematically illustrating one embodiment of consumer enrollment component according to this invention;

FIG. 3 is a block diagram schematically illustrating one embodiment of reconciliation component according to this invention; and

FIG. 4 is a schematic illustration of seven representative inputs that may be factored into one embodiment of energy price protection system according to this invention.

### DETAILED DESCRIPTION OF PREFERRED EMBODIMENTS

In the description that follows, terms such as fuel, gasoline, natural gas, diesel fuel, heating oil, propane, etc., may be used. Generally, these terms are used equivalently and interchangeably to represent a generic energy type unless otherwise specifically indicated or indicated by context. Also, terms such as purchase, sale, lease, rent, etc., may be used equivalently and interchangeably unless otherwise specifically indicated or indicated by context.

Energy Price Protection (EPP) is a unique and innovative product concept that allows residential and commercial users of fuel or energy (including natural gas, electricity, gasoline, propane and fuel oil) to protect them against increasing energy costs. A consumer signs up for a protection plan that consists of a protection price, a protection amount and a protection term. Each subscribing consumer will be able to choose one or more types of energy to protect.

The energy protection price is selected using data collected and maintained by EPP. This reference data is based upon standard, objective market prices which are geographic specific and collected from various reporting services, commodity exchanges and/or administrative agencies which could include the NYMEX, Energy Information Administration and the Oil Price Information Service. Such market prices will act as a reference for what the consumer will actually pay for a given type of energy. The methodology for establishing a transparent, third-party generated, objective price reference is an integral and unique part of the current invention.

In return for providing the protection plan, consumers will pay EPP a one-time service fee for each contract term. The amount of that fee will be determined by the specifics of the protection plan, i.e. protection price, protection amount and term of protection/coverage. Consumer enrollments will primarily occur through a web-based portal with payment being made via a credit/debit card and/or with an electronic funds transfer (EFT)/automated clearing house (ACH) type transactions.

The basics for protection by the system and method of this invention are as follows:
If during the protection term, the reference market price for a given energy type averaged over a specified period, e.g., one month, exceeds the protection price, the customer is eligible for a refund or EPP credit.
The EPP credit shall equal the difference between the average market reference price and the consumer's protection price multiplied by a contracted consumption amount agreed to between the consumer and the EPP provider.
EPP credits will be calculated at specified intervals, stated in the contract, and, if desired, credited back to the consumer using the same method for paying the initial service/subscription fee.

### Proprietary Web-Based Platform

EPP is a fully-functional, scalable e-commerce platform that allows consumers to: (1) determine which protection plan fits their needs; (2) enroll in the plan(s); (3) pay online; (4) monitor the reconciliation of their plan(s) versus the specific market reference price(s); (5) receive credits; and (6) renew once their protection term(s) has expired. It is NOT contingent on any actual purchase of energies and/or eventual consumer deliveries of same!

The process for enrolling (or subscribing) is simple and straightforward. Preferably, initial enrollment should not take more than twenty minutes. EPP will provide various charts and tools to assist consumers in making the appropriate choice for their specific energy needs.

### Pricing and Risk Management Infrastructure

EPP utilizes a number of proprietary pricing and risk management tools to price the various protection plans. A main goal of this system and method is to mitigate exposure to market fluctuations, thereby facilitating planning and budgeting by the consumer. Each protection plan is individually priced based on:

1. The Consumer's Geographic Location

2. The Energy Type(s) selected by the Consumer

3. A Market Reference Price for each Energy Type Chosen

4. A Protection Price

5. A Protection Amount

6. An Initial Protection Term (renewable and extendible); and

7. The Initial Date of Consumer Enrollment

EPP will aggregate energy protection plans with similar characteristics and then purchase energy products using various hedging tools from the financial marketplace to ensure that EPP's subscribing customers receive the value promised.

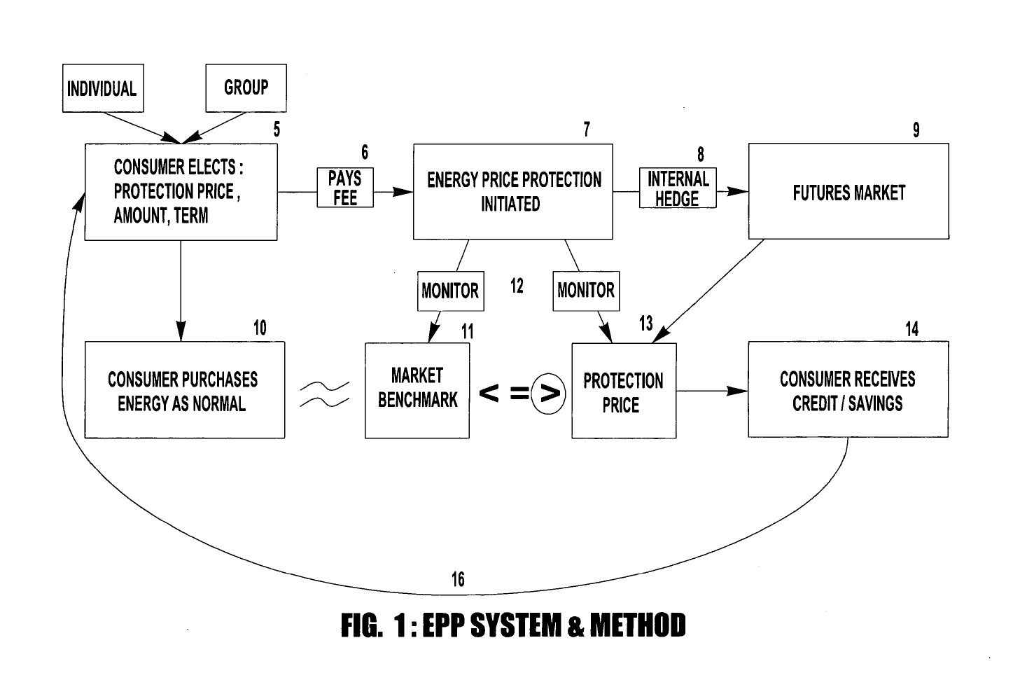

In the accompanying drawings, like referenced numerals designate like parts in the several figures. Referring now to FIG. 1, there is shown a block diagram of a system or method according to one embodiment of this invention. Therein, the EPP system is includes at least one Provider 7 who provides energy price protection to a subscribing Consumer 5. Energy price protection may be provided in one or more ways. For example, Provider 7 may provide protection directly to Consumer 5 enrolled in the protection plan. Alternately, Provider 7 may provide indirect price protection, most likely, to a group of common consumers (by their respective enrollments in a purchasing group, association, subscriber/membership base, franchisee(s), etc). Payment for enrollment in this energy price protection system may be provided by credit card, debit card or ACH transaction.

Provider 7 provides price protection assurances to Consumer 5 that over a given period of time (sometimes referred to as a limited time period or term), Consumer 5 can buy one or more energy types for his residence and/or business at a price that does not exceed a given market reference price (sometimes referred to as a predetermined price, prescribed pricing or the like). The average market reference price may be determined using an independent indicator of the price, such as the New York Mercantile Exchange. The average market reference price may also be determined with respect to geographical considerations, e.g., within a city, county, state or some other region where Consumer 5 resides.

The average market reference price may include taxes and/or other add-ons in addition to the price of the fuel. The quantity of energy for which price is protected over time may also be predetermined. The duration that price protection may be provided may be a number of months, e.g., from six months to about three years (sometimes referred to as the protection term or simply “term”). It will be appreciated that the values expressed are exemplary only and may be more or less than those expressed. For example, the time period may be more or less than one month; the predetermined protection price something other than average price per month; and the protection term more or less than six to thirty-six months (six months to three years).

The EPP Provider 7 will, most likely, perform some energy price hedging during a given energy consumption period. Hedging allows Provider 7 to supply energy price protection even though actual prices for fuel oil, electricity, natural gas, etc. may vary over time. Examples of hedges include one or more of acquiring by purchase or otherwise options (e.g., calls, puts, etc.), futures, derivatives, combinations of the foregoing and/or other instruments or mechanisms that may be purchased and sold to provide funding to pay Provider Ito fulfill the obligations promised to Consumer 5.

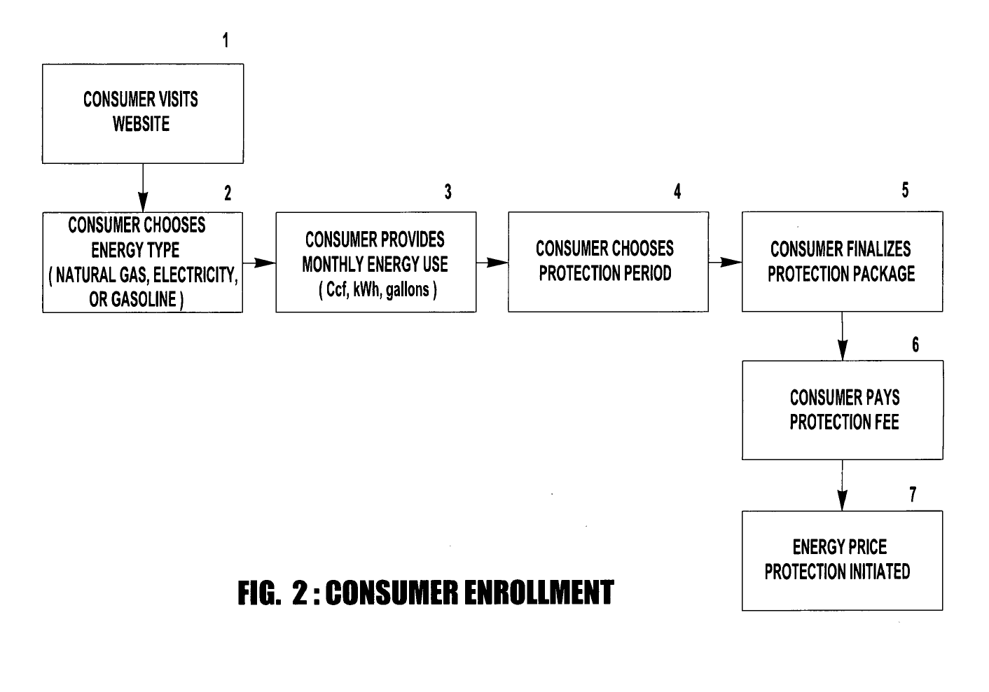

Turning now to FIG. 2, there is shown a block diagram illustrating how a Consumer 5 enrolls according to one embodiment of this invention. Particularly, at Block 2, Consumer 5 may select from one of several offered energy price protection plans. For a given energy type and/or geographic location, it may be the case that only one variety of EPP will be offered . . . possibly for a limited time until other providers and/or energy delivery means become available. At Blocks 2 through 4, the size, timing and cost of the EPP that the Consumer selects are calculated. Note also that in Block 3, the Consumer provides monthly energy use (kWh, gallons, Ccf). A preliminary price or Fee 6 to charge Consumer 5 may be determined by this calculation.

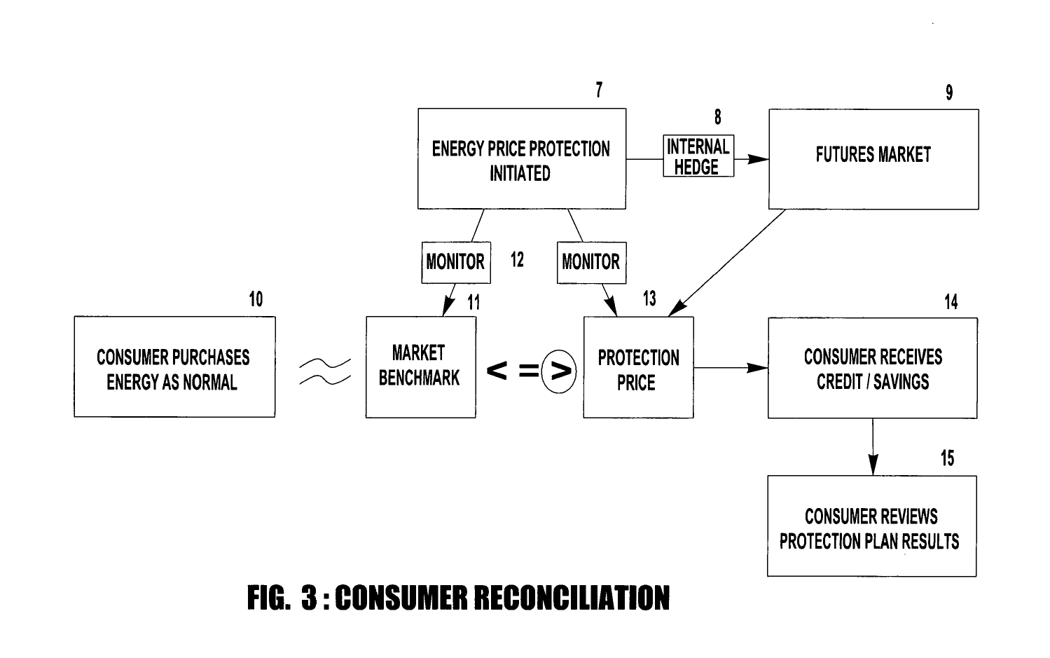

Thereafter, the risk of price increases is converted into terms that can be hedged in the financial market (See especially, Block 8 of FIG. 1). Examples of such hedge instruments include options, futures, derivatives, combinations and/or other instruments. As an example, an option to purchase a quantity of natural gas or crude oil at a given price may be purchased. If the price of fuel increases, the option increases in value and may provide some or all of the funds or other value needed to issue Consumer 5 a refund/credit per FIG. 3.

Turning now to FIG. 3, there is shown a block diagram illustrating one representative means for a Consumer 5 to redeem or reconcile past credits/refunds earned in the EPP. Specifically, at Block 14, credits are returned to the Consumer based on the Monitoring 12 and calculating carried out earlier. Preferably, the credit payment takes the same form of payment by the Consumer in paying his/her initial subscription or service Fee (Block 6 in FIGS. 1 and 2).

At Block 15 of FIG. 3, the calculated changes and/or other account information may be posted for review by the subscribing Consumer. Security will be provided so that the Consumer may review only his or her own records. Loop line 16 in FIG. 1 depicts the possibility of repeating the above described steps for also meeting the same Consumer's business energy needs.

The various methodologies described herein may be implemented using financial instruments, such as a swap, call option, put option, or the like. As is well known, a swap is a derivative, where two counter parties exchange one stream of cash flows against another stream. The cash flows are calculated over a notional principal amount. A call option provides the right but not the obligation to buy at a specified price. A put option provides the right but not the obligation to sell at a specified price. The call option and/or put option each can have an expiration date in which they are lost if not executed prior to expiration. Preferably, the call option is based on the average price each day over the period of the agreement. The particular options that may be implemented for each of the price protection methodologies are described in more detail below.

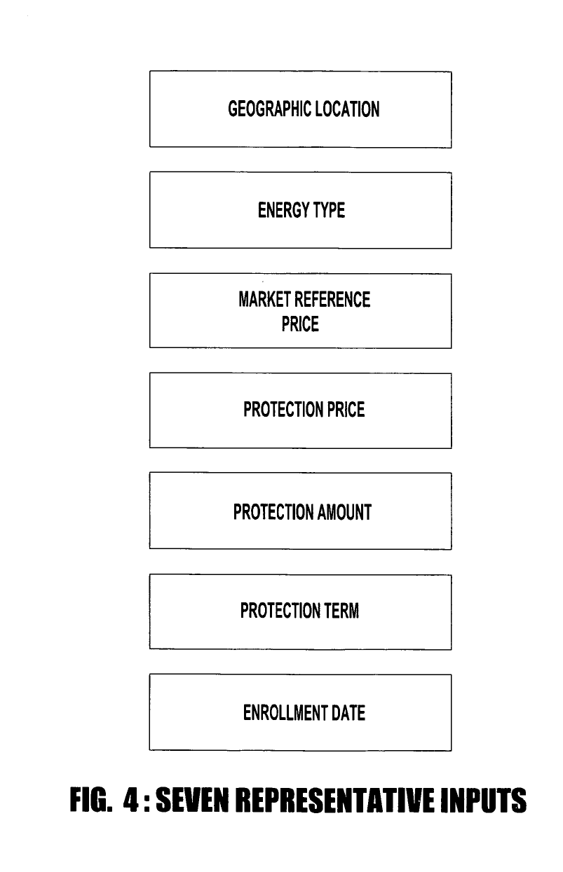

In accompanying FIG. 4, there is shown, in separate blocks, seven representative inputs for one embodiment of system and method according to this invention. Specifically, they include: Geographic Location; Energy Type; Market Reference Price; Protection Price; Protection Amount; Protection Term and Enrollment Date. Still others may be added as this system and method further evolves.

### EXAMPLES

If the average reference price of fuel at the time of the agreement is $3.00 per gallon and the Consumer elects to purchase an EPP at the protection price of $3.20 per gallon, then a call option is placed at $3.20 per gallon. If the average reference price of fuel prices increases above $3.20 per gallon, then the option protects the Provider from the price increase. The difference between the protection level ($3.20 per gallon) and the average market reference price is then calculated and multiplied by the agreed to monthly protection amount with the resulting dollar amount credited back to the Consumer . . . once again, regardless of the amount of fuel actually bought, delivered and/or used by this Consumer!

Assuming a market reference price of $3.50 and a protection amount of 65 gallons per month the following calculation would occur:

$3.50−$3.20*65=$19.50 credited back to the Consumer for that time period.

If the average market reference price is less than the protection price for a particular term, the Provider does not “owe” the Consumer any credit for that period of time. Presumably, the Consumer did, in fact, buy his/her fuel needs at that lower market price (from any supplier of same), and said Consumer still enjoyed the benefits of lower-than-anticipated retail fuel prices. This subscribing Consumer also “enjoyed” the peace of mind that he/she would not pay more than a certain retail price for the term in question (once the credit for higher than expected pricing is taken into account).

Although specific computer program code is not illustrated or described herein, it will be appreciated that a person who has ordinary skill in the field of computer programming and/or in the field of finance would be able to write a computer program in an appropriate computer program language to carry out the functions described herein.

What is claimed is:

1. A method of providing energy purchase price protection to multiple users for their home or business facilities, said method comprising:
(a) providing a system that includes:
a processor; and
a memory operatively connected to said processor that, with control instructions in said memory, performs the steps of:
(i) receiving an account identifier for each user;
(ii) receiving an anticipated geographic area associated with energy purchases from each user;
(iii) storing said received anticipated geographic areas in association with each respective account identifier in said memory; and
(iv) providing each user a subscription fee calculated by said processor based on:
a first program price associated with each user,
a second program price associated with each user, and
a market reference price,
the first and second program prices for each user being independent of the first and second program prices for each other user, and each subscription fee being based on: said first program price as correlated to said user's anticipated geographic area; and on said second program price not corresponding to said user's anticipated geographic area; and
(b) inputting data for each user into said system;
(c) monitoring said market reference price; and
(d) providing each user a credit calculated by said processor should said market reference price exceed said second program price for that user.

2. The method of claim 1, wherein at least one of said first program price and said second program price for each user is a capped price.

3. The method of claim 1, wherein said first program price and said second program price for each user is set for at least one of: an effective time period, possible quantity of energy to be purchased by each user in said effective time period, and grade of energy to be purchased.

4. The method of claim 3, wherein said effective time period may be renewed by each user for at least one of:
a lesser term or first full renewal of said effective time period; and
a lesser, greater or same quantity of energy to be purchased, upon user payment of a preset renewal fee.

5. A method of providing transactional energy price protection to a consumer for a preset quantity of energy that may be purchased over a preset time period for said consumer's home or business, said method comprising:
(a) providing a system that includes:
a processor; and
sufficient processor-connected, memory to perform the steps of:
receiving an account identifier for said consumer;
receiving an anticipated geographic area in which said consumer would make one or more types of energy purchases for said consumer's home or business;
storing said received anticipated geographic area in said memory for said consumer's account identifier; and
(b) using said said processor of said system to calculate a subscription fee specific for said consumer based on:
a first value for said consumer,
a second value associated with each consumer of similar energy purchases,
and
a market reference value,
(c) monitoring said market reference value; and
(d) paying said consumer when the second value exceeds the first value regardless of whether said consumer purchases any amount of energy at said second value.

6. The method of claim 5, wherein the second value is an average market reference value for energy purchased during the preset time period.

7. The method of claim 5, wherein said consumer may renew its subscription for the same or lesser term before its preset time period expires.

8. The method of claim 5, which provides said consumer with price protection for its residential utility purchases.

9. The method of claim 5, which guarantees said consumer that its effective cost per energy unit over a given time period will not exceed a predetermined price.

10. The method of claim 9, said guaranteeing comprises acquiring financial instruments to protect against rises in cost per energy unit over a time period that is the same or different from said consumer's given time period.

11. A method for providing price protection for a plurality of consumers that repeatedly purchase energy products for their home or business structure, said method comprising:
(a) providing a system that includes:
a processor; and
a memory operatively connected to said processor with control instructions for performing the steps of:
(i) receiving an account identifier associated with each subscribing consumer;
(ii) receiving, from each subscribing consumer, an anticipated geographic area associated with that consumer's structural energy purchases;
(iii) storing in said memory said received anticipated geographic areas in association with each respective account identifier; and
and
(iv) providing each consumer a subscription fee calculated for a first prescribed time frame by said processor based on:
a first program price associated with each consumer, and
a second program price associated with each consumer,
the first and second program prices for each consumer being independent of the first and second program prices for each other consumer, and each subscription fee being based on: said first program price as correlated to said consumer's anticipated geographic area; and on said second program price not depending on said consumer's anticipated geographic area;
(b) acquiring financial instruments to acquire energy products at future times, based on:
a cost to acquire such financial instruments;
an anticipated value of such financial instruments during said first prescribed time frame; and
an anticipated average price for energy product during a second time frame; and
(c) providing each consumer a processor-calculated payment based on a difference between a first value of an established market value energy price and a second value related to each consumer's actual energy price quantity if the second value exceeds the first value.

12. The method of claim 11, wherein the actual value is average value.

13. The method of claim 11, wherein such financial instruments are energy purchase options.

14. The method of claim 11, wherein said acquiring financial instruments step (b) includes:
acquiring options for future purchases of at least one of: home heating oil, natural gas and electricity.

15. The method of claim 11, which further comprises:
investigating at least one of the factors of energy market supply; and
determining hedges to compensate for fluctuations in said investigated factors.

16. The method of claim 11, wherein said providing each consumer payment step (c) includes:
crediting said consumer based on:
an average structural energy price over a prescribed time period,
a guaranteed structural energy price, and
an agreed to quantity of structural energy for purchase by said consumer, provided the average structural energy price over the prescribed time period exceeds the guaranteed structural energy price during that prescribed time period without regard to whether the agreed to quantity of structural energy was used by said consumer.

17. The method of claim 16, which includes:
basing structural energy price protection on: a wholesale price component set by an independent entity, a retail price component, or both components.

18. The method of claim 17, wherein basing structural energy price protection on said retail price component includes: basing said retail price component on a wholesale energy price component and a market price for said structural energy.

19. The method of claim 18, wherein providing structural energy price protection includes: using at least one of fixed price protection, price increase protection, or price buy down.

20. The method of claim 19, wherein using price buy down includes implementing price buy down via a swap agreement, a put option, or both.
